(19) United States
(12) Patent Application Publication
(10) Pub. No.: US 2012/0174341 A1
(43) Pub. Date: Jul. 12, 2012

(54) Universal mounting platform and method for attaching same to garments

(75) Inventors: William H. Rogers, St. Augustine, FL (US); Matthew E. McKendrick, Jacksonville, FL (US)

(73) Assignee: Prezine, LLC

(21) Appl. No.: 12/316,562

(22) Filed: Dec. 12, 2008

Related U.S. Application Data
(60) Provisional application No. 61/007,857, filed on Dec. 17, 2007.

(51) Int. Cl. A44B 17/00; B23P 11/00

(52) U.S. Cl. 24/3.1; 29/428

(57) ABSTRACT

A platform to which an article is attached on its front surface thereof and having two pair of spaced prongs extending from the back surface adjacent one edge portion thereof and facing inwardly and opposing spaced prongs adjacent the opposite edge portion of the platform. The prongs snugly fit within spaced horizontal loops of a MOLLE/PALS compliant garment or similarly designed garment. The garment must be temporarily folded horizontally to attach the prongs to garment loops and when released the webbing between the prongs and the back surface bunches up and is wedged therebetween.

### CROSS-REFERENCE TO RELATED APPLICATION

This application claims priority to provisional application 61/007,857, filed Dec. 17, 2007, entitled PALS Universal Mounting Platform (attorney docket number D-7802).

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

This invention relates generally to connectors, fasteners and attaching systems to secure articles to a garment or the like, and more particularly, to an attaching system for readily removing and securing holsters, pouches or other modular accessories to a MOLLE-compliant garment or a similarly designed garment.

2. Relevant Art MOLLE is an acronym for MOdular Lightweight Load-carrying Equipment. It is used to define the current generation of load-bearing equipment and rucksacks utilized by the United States Army. The modularity of the system is derived from the use of Pouch Attachment Ladder System or PALS webbing, rows of heavy-duty nylon precisely stitched onto the vest as to allow for attachment of various MOLLE-compatible pouches and accessories. This method of attachment has become a standard for all quality modular military gear, replacing the click and stick system used in the earliest modular vest systems (which is still in use with most Western police departments). It is produced for the United States Government under contract by several contractors. See for example, U.S. Pat. No. 5,724,707.

PALS is a grid of webbing invented and patented by United States Army Natick Soldier Research, Development and Engineering Center and is used to attach smaller equipment onto load-bearing platforms, such as vests and backpacks. It was first used on MOLLE rucksacks, but is now found on a variety of American equipment, such as the Improved Outer Tactical Vest, Interceptor body armor, USMC Improved Load Bearing Equipment backpack and Modular Tactical Vest. It is used to readily attach items such as holsters, magazine pouches, radio pouches, knife sheaths, and other gear. A wide variety of pouches are commercially available, allowing soldiers to customize their kit. There are also a variety of attachment methods, including the Malice Clip, the Natick snap, and soft, interwoven straps. See for example, U.S. Pat. Nos. 7,080,430; 7,200,871; and 7,240,404. The PALS system has been adopted by other forces, such as the British Army, who use it on their Osprey body armor.

The PALS grid consists of horizontal rows of 1″ Mil-W-43668 Type III nylon webbing (most commercial vendors use Type 111a), spaced 1″ apart, and reattached by reinforced stitches or seams to the backing at 1.5″ intervals.

There have been numerous designs developed so that the user can securely attach an article to the MOLLE/PALS system. These designs can take considerable time to secure and remove the article. Most of the new designs use additional parts to interlock to the PALS system, while the older products use lacing fabric straps. They are secure but in many cases are not stable and have a great deal of movement. For articles such as hydration bags or radio pouches, movement is usually not a detriment. However, the attachment of a pistol holster for quick deployment of the pistol can be a different matter. The holster should be on a stable platform so that the user can quickly get a proper grip on the pistol and release the pistol from the holster.

### BRIEF SUMMARY OF THE INVENTION

The present invention provides a mounting platform to allow the user to quickly mount in a stable manner practically any article, including a pistol holster, to a MOLLE vest without the need of additional parts or special tools. The mounting platform removably secures an article mounted thereon to a MOLLE/PALS compliant garment or similarly designed garment having a grid with horizontal rows of webbing spaced apart at precise repeated dimensions and such webbing has spaced loops of repeated dimensions with the loops of each row being vertically aligned.

The platform is riveted or bolted onto an article which will be attached to the garment. Various sizes of platforms depend on the article it needs to support. The platform is generally a flat plate with multiple spaced holes for attaching to a variety of articles. In a preferred embodiment, at least two prongs are provided on one side of the plate in respective corners associated with one plate end and an opposing set of at least two prongs in respective corners of the opposite end of the plate. The opposing prongs have their free, distal ends facing each other and are designed to slip into the vertical loops formed by the PALS webbing or similar design. Each prong is tapered, being thicker at its proximal end where it attaches to the plate member and thinner at its free, distal end, permitting easy insertion of the prong into a loop. The proximal end of the prong adjacent to where it attaches to the plate member is of a thickness that allows the prong to substantially fill the entire internal area of the loop, making the attachment to the webbing secure.

Installation of the platform is as follows: the two prongs of one end of the plate are engaged into the corresponding loops of the PALS webbing. The garment material is folded sufficiently to allow the opposing prongs at the opposite end of the plate to engage the loops which closely align with the end of the plate. When the garment is unfolded and returns to its normal original shape, the plate is secured firmly in place and provides a stable mounting platform for the article. The prongs are wedged within the loops and apply forces to the plate member in opposing directions insuring that the plate member remains secure until it is removed by refolding of the garment.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description taken in connection with the accompanying drawings, in which:

FIG. 1 is a front elevational view of a first embodiment of a mounting platform in accord with the invention;

FIG. 2 is a right side elevational view of the first embodiment shown in FIG. 1;

FIG. 3 is a bottom plan view of the first embodiment shown in FIG. 1;

FIG. 4 is a rear perspective view of a second embodiment of a mounting platform in accord with the invention;

FIG. 5 is a front perspective view of the second embodiment shown in FIG. 4;

FIG. 6 is a front elevational view of a third embodiment of a mounting platform in accord with the invention;

FIG. 7 is a rear elevational view of the third embodiment shown in FIG. 6;

FIG. 8 is a right side elevational view of the third embodiment shown in FIG. 6;

FIG. 9 is a bottom plan view of the third embodiment shown in FIG. 6;

FIG. 10 is a front elevational view of the second embodiment shown in FIG. 4 attached to the PALS webbing used for MOLLE compatible articles;

FIG. 11 is a cross sectional view taken along line 11-11 of FIG. 10;

FIG. 12 is a front perspective view of FIG. 10;

FIG. 13 is a front elevational view of a fourth embodiment of a mounting platform in accord with the invention; and

FIG. 14 is a left side elevational view of the fourth embodiment shown in FIG. 13.

### DETAILED DESCRIPTION OF THE PRESENT INVENTION

It should be noted that herein a “rectangle” is defined as a parallelogram all of whose angles are right angles. A “square” is defined as a rectangle with all four sides equal. Thus, a square is a form of rectangle.

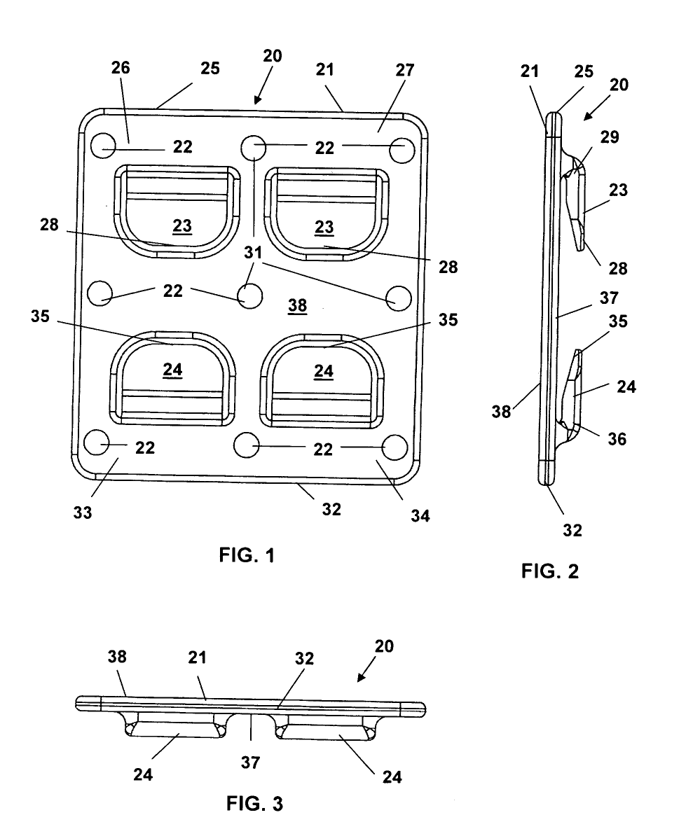

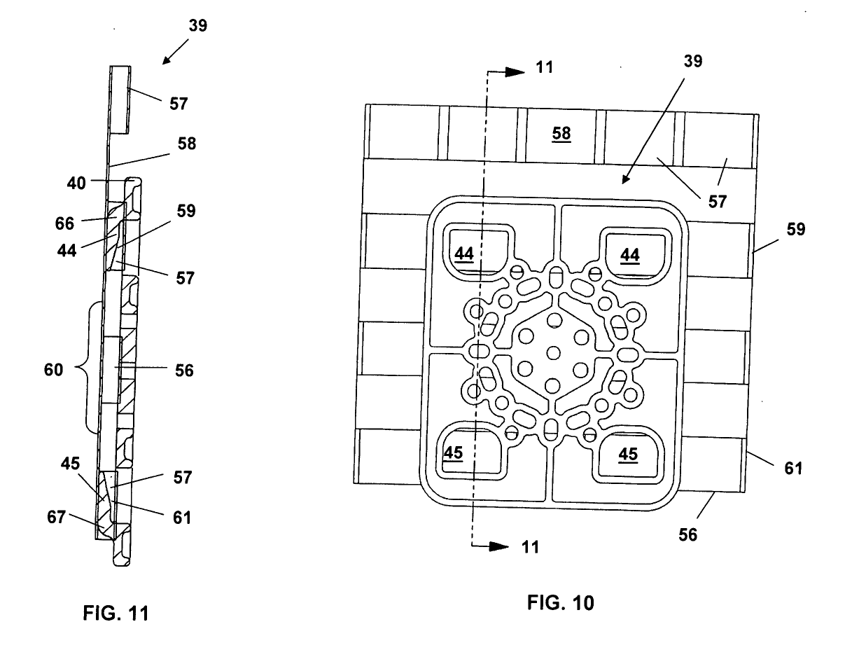

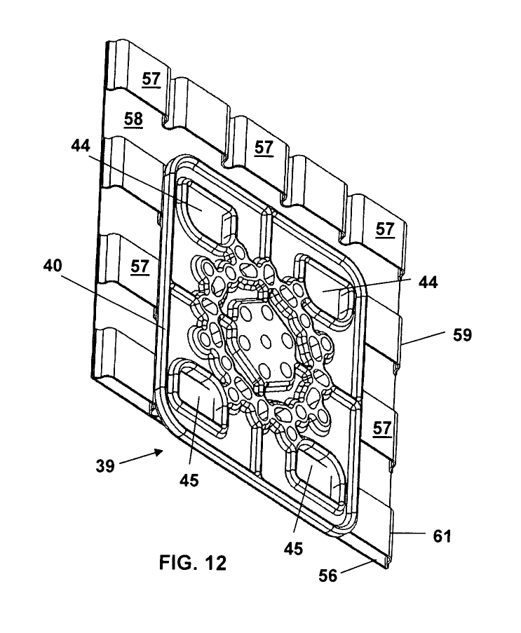

Referring now more particularly to FIGS. 1-3, the first embodiment of the invention is depicted and the platform is designated generally by reference numeral 20 and is preferably made of strong rigid plastic material molded into the form depicted. The platform 20 includes a generally planar plate member 21 having a rear surface 37 (see FIGS. 2 and 3), a front surface 38, and a plurality of spaced openings 22 (see FIG. 1) that extend through the surfaces 37, 38 and to which an article is affixed permanently or by releasable fasteners such as nuts and bolts (not shown). At least two spaced prongs 23 (see FIGS. 1 and 2) are integral with plate member 21 and extend from a first side 25 (see FIGS. 1 and 2) adjacent respective corners 26 and 27 (see FIG. 1). The prongs 23 have respective proximal ends 29 (see FIG. 2) that are attached to the plate member 21 and respective distal ends 28 (see FIGS. 1 and 2) located generally medially of plate member 21. An opposing pair of spaced prongs 24 are integral with plate member 21 and extend from an opposing second side 32 adjacent respective corners 33 and 34 (see FIG. 1). The prongs 24 have respective proximal ends 36 (see FIG. 2) and also have respective distal ends 35 (see FIGS. 1 and 2) that are located generally medially of plate member 21. The distal ends 35 face the opposing distal ends 28 of prongs 23, as most clearly illustrated in FIG. 2. The prongs 23, 24 are spaced approximately equidistant from the rear surface 37 so that fabric webbing 56 depicted in FIGS. 10-12 may be disposed therebetween as hereinafter more specifically described. The platform 20 of FIGS. 1-3 illustrates a generally square platform which may support a number of different articles which may be riveted or bolted thereto.

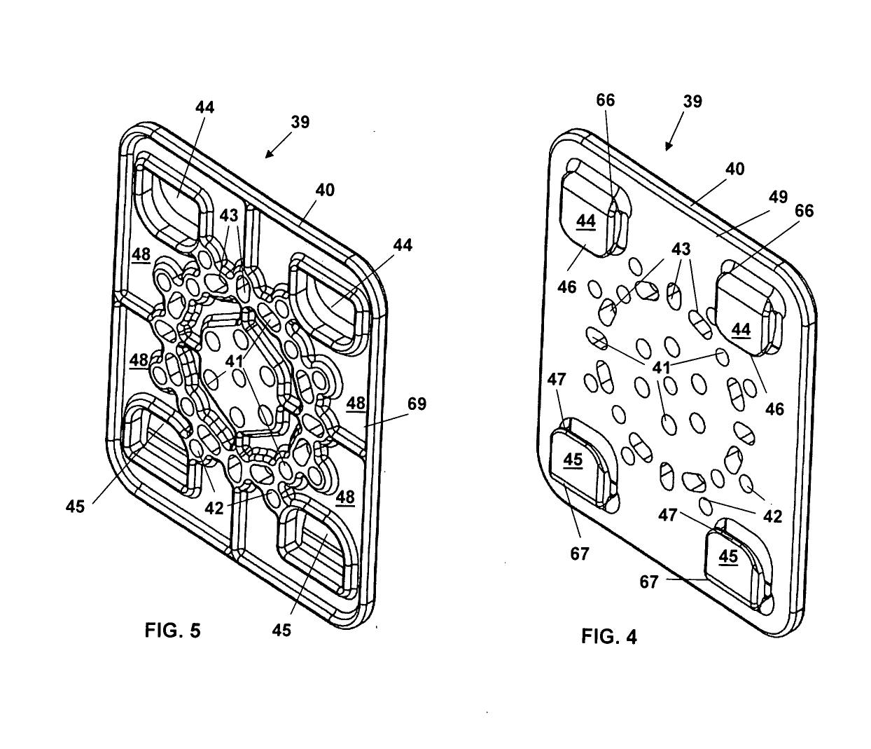

A second embodiment shown in FIGS. 4 and 5 illustrates a platform identified by numeral 39 that comprises a plate member identified by numeral 40. The hole pattern 41 of the plate member 40 differs from the hole pattern 31 of plate member 21 to provide added flexibility in attaching articles to the platform 39. Note that the hole pattern 41 of plate member 40 includes spaced round holes 42 as well as spaced slots 43 to provide such connection enhancements. The prongs 44, 45, like prongs 23, 24 of FIGS. 1-3, have distal ends 46, 47 (see FIG. 4) which are rounded or slightly tapered to readily fit into loops 57 of webbing 56 to be described in more detail hereinafter with respect to FIGS. 10-12.

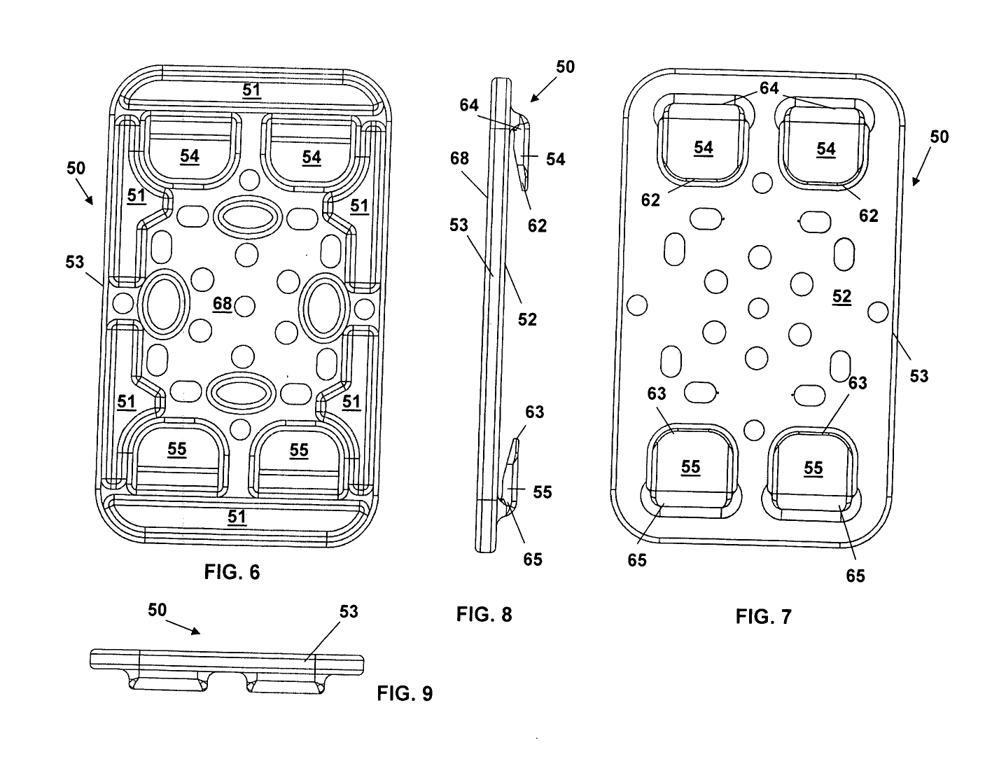

A third embodiment shown in FIGS. 6-9 illustrates a platform identified by numeral 50. The platform 50 basically differs from the aforementioned platforms 20 (see FIGS. 1-3) and 39 (see FIGS. 4 and 5) by being generally rectangular, for example, 3″×2″, whereas the platforms 20 and 39 may be generally square, for example 2″×2″. The prongs 54, 55 (see FIGS. 6-8) of the platform 50 are substantially the same as prongs 23, 24 (see FIG. 1) and prongs 44, 45 (see FIGS. 4 and 5).

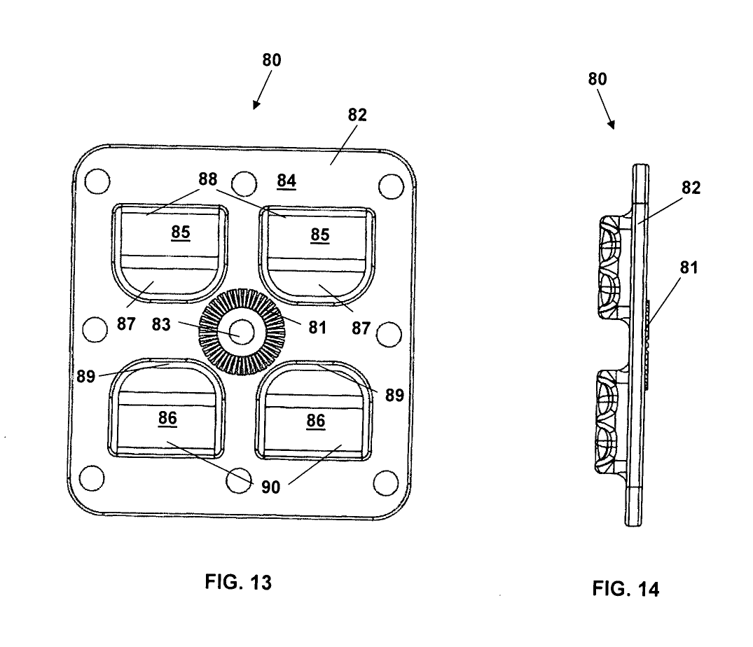

A fourth embodiment, shown in FIGS. 13 and 14, illustrates a platform identified by numeral 80. The platform 80 basically differs from the aforementioned platforms 20 (see FIGS. 1-3), 39 (see FIGS. 4 and 5), and 50 (see FIGS. 6-9) by having a locking spline 81 formed integrally with a front surface 84 (see FIG. 13) of a planar plate member 82. In the approximate center of the spline 81 is an attaching hole 83 (see FIG. 13) that extends through the plate member 82. Small articles that are to be mounted on the platform 80 can have a ribbed or spline connection that mates with the spline 81 of the platform 80, allowing such an article to be positioned at various angular relationships with the platform 80. For example, angular relationships of about 15 degree increments are possible. A fastener (not shown) passes through the hole 83 in the center of the spline 81 to secure the platform 80 to the article. The prongs 85, 86 (see FIG. 13) of the platform 80 are substantially the same as the prongs 23, 24 (see FIG. 1) of platform 20 (see FIGS. 1-3).

Note, as can be seen with reference to FIGS. 2, 4, 8, and 13, the prongs 23, 24, 44, 45, 54, 55, 85, 86 of each of the four embodiments 20, 39, 50, 80 are thinner at their distal ends 28, 35, 46, 47, 62, 63, 87, 89 and thicker at their proximal ends 29, 36, 66, 67, 64, 65, 88, 90, so that the prongs 23, 24, 44, 45, 54, 55, 85, 86 are wedged into the loops 57 of the webbing 56, thereby securing the platform 20, 39, 50, 80 in the webbing 56. Also note that normally the larger the platform 20, 39, 50, 80, the greater size and/or weight of the article that is to be mounted thereto. Accordingly, the width of plate member 21 (see FIG. 2), plate member 40 (see FIGS. 4 and 5), or plate member 82 (see FIG. 14) may be about 3/16″, whereas the width of plate member 53 (see FIG. 8) may be ¼″. Further note that as is common in the molding of plastic material, reduction in weight and amount of material is provided by depressions, such as depressions 51 (see FIG. 6) in a front surface 68 (see FIGS. 6 and 8) of the plate member 53 or depressions 48 (see FIG. 5) in a front surface 69 (see FIG. 5) of the plate member 40.

FIGS. 10-12 illustrate generally the attachment of the platform 39 to loops 57 of webbing 56 of a garment 58 that is MOLLE/PALS compliant or to a substantially similarly designed garment 58 having a grid of generally horizontal rows of substantially non-stretchable webbing 56 forming precise loops 57 and precise spaces between the rows of loops 57 with the loops 57 being substantially aligned vertically. (See U.S. Pat. No. 5,724,707.) The webbing 56 is usually a woven nylon strap that is substantially non-stretchable and not easily bendable. The platform 39 is secured to the webbing 56 by initially placing one set of prongs 44 beneath loops 57 in loop row 59 and then partially folding the garment beneath the plate member 40, as for example in area 60 (see FIG. 11), so that the opposite set of prongs 45 may slip into aligned loops 57 on the spaced loop row 61, and the garment 58 is unfolded or flattened to its normal shape thereby firmly securing the platform 39 in place. To unsecure the platform 39, the garment 58 must be creased or refolded in area 60 and either set of prongs 44 or 45 is removed from the loops 57, whereupon the opposing set of prongs 45 or 44 may be slipped out of the loops 57. Note that platforms 20, 50, and 80 can be secured and unsecured to the loops 57 of the webbing 56 of the garment 58 in generally the same way as platform 39.

As shown in FIG. 11, the loop 61 tends to “bunch up” generally where each proximal end 66, 67 meets the plate member 40, so that forces produced by such bunching exert outwardly directed forces on such junctions, i.e., forces tending to compress the loops 57 together and/or tending to tension the plate member 40. Furthermore, as set forth hereinabove, the prongs 44, 45 function as wedges to tightly grip the loops 57, which enhances the firm securing of the plate member 40 to the loops 57 and garment 58.

A method for securing articles to a garment 58 can be employed with each of the four embodiments of the present invention 20, 39, 50, 80 described herein. First, an article is affixed to a platform 20, 39, 50, 80 by passing a fastener through an opening in a plate member 21, 40, 53, 82 of the platform 20, 39, 50, 80, thereby securing the article to a front surface 38, 69, 68, 84 of the plate member 21, 40, 53, 82. Second, a pair of prongs 23, 24, 44, 45, 54, 55, 85, 86 of the platform 20, 39, 50, 80 are inserted into respective spaced loops 57 in a first horizontally disposed webbing 56 of the garment 58. Third, a portion of the garment 58 is partially folded horizontally beneath the platform 20, 39, 50, 80 to permit a second opposing pair of prongs 23, 24, 44, 45, 54, 55, 85, 86 of the platform 20, 39, 50, 80 to be inserted into respective aligned spaced loops 57 in a second horizontally disposed webbing 56 of the garment 58. Last, the garment 58 is unfolded, thereby securing the platform 20, 39, 50, 80 and the affixed article to the garment 58.

To remove the platform 20, 39, 50, 80 from the garment 58, the portion of the garment 58 beneath the platform 20, 39, 50, 80 is partially folded horizontally. Next, one pair of prongs 23, 24, 44, 45, 54, 55, 85, 86 is removed from the respective loops 57 in the first horizontally disposed webbing 56 of the garment 58. Last, the remaining pair of prongs 23, 24, 44, 45, 54, 55, 85, 86 is removed from the respective loops 57 of the second horizontally disposed webbing 56.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. A platform for removably securing articles to a garment comprising:
a generally rectangular, substantially planar plate member having a front surface, a rear surface, opposing first and second side portions, and a plurality of spaced openings extending through said plate member for affixing articles thereto;
at least two opposing pairs of spaced prongs for securing said plate member to a garment, each said prong of said pairs of prongs having a free distal end and an opposing proximal end attached to said rear surface of said plate member, each said prong being spaced approximately equidistant from said rear surface so that fabric of a garment onto which said plate member is to be mounted can be disposed between each said prong and said rear surface; and
a first pair of said prongs extending from adjacent said first side portion of said plate member, said prongs of said first pair being spaced a predetermined distance, and an opposing second pair of prongs extending from adjacent said second side portion of said plate member, said prongs of said second pair being spaced said predetermined distance, said distal ends of said first and second pairs of prongs being located generally medially of said plate member, and said distal ends of said first pair of prongs facing said distal ends of said second pair of prongs.

2. The platform as defined in claim 1, wherein each said prong is thinner at said distal end than at said proximal end, each said distal end being substantially rounded, such that the shape of said prongs permits easy insertion and wedging of respective said prongs into respective loops of fabric on the garment, said prongs when fully inserted into respective loops substantially fill same.

3. The platform as defined in claim 2, wherein:
said prongs of said first pair of prongs being vertically aligned and said prongs of said second pair of prongs being vertically aligned; and
a first prong of said first pair of prongs being horizontally aligned with a first prong of said second pair of prongs, and a second prong of said first pair of prongs being horizontally aligned with a second prong of said second pair of prongs.

4. The platform as defined in claim 1, wherein one of said prongs of said first pair of prongs being horizontally aligned with one of said prongs of said second pair of prongs.

5. The platform as defined in claim 4, wherein another of said prongs of said first pair of prongs being horizontally aligned with another of said prongs of said second pair of prongs.

6. The platform as defined in claim 1, wherein said plate member further includes a locking spline for affixing an article to said platform at a plurality of angles relative thereto, said locking spline attached to said front surface of said plate member and surrounding an attaching hole extending through said plate member.

7. The platform as defined in claim 1, wherein said plate member includes a plurality of weight-reducing depressions in said front surface spaced from said prongs and said spaced openings.

8. The platform as defined in claim 1, wherein said proximal end of each said prong is formed integrally with said rear surface of said plate member.

9. The platform as defined in claim 1, wherein said prongs of said first pair of prongs being vertically aligned and said prongs of said second pair of prongs being vertically aligned.

10. The platform as defined in claim 1, wherein:
said prongs of said first pair of prongs being vertically aligned and said prongs of said second pair of prongs being vertically aligned; and
a first prong of said first pair of prongs being horizontally aligned with a first prong of said second pair of prongs, and a second prong of said first pair of prongs being horizontally aligned with a second prong of said second pair of prongs.

11. A system for removably securing articles to a garment comprising:
a garment having a plurality of equally spaced, substantially horizontal webbings, each said webbing containing a plurality of spaced, equally sized loops, said loops of each said webbings being vertically aligned;
a platform having a substantially planar plate member and at least two opposing pairs of spaced prongs for securing said plate member to said webbings of said garment, said plate member having a front surface, a rear surface, and a plurality of spaced openings extending through said plate member for affixing articles thereto, each prong of each said pair of prongs having a free distal end and an opposing proximal end attached to said rear surface of said plate member, with said free distal ends of a first said pair of prongs facing said distal ends of a second said pair of prongs, each said prong being spaced equidistant from said rear surface;
said webbings being secured to said garment at equally spaced apart locations, said loops in each said webbing being at equally spaced apart locations, spacing between locations of said loops and spacing between locations of said webbings being substantially equal; a first prong of said first pair of prongs being received through a first loop of a first said webbing and an opposing first prong of said second pair of prongs being received through a first loop of a second said webbing; and
a second prong of said first pair of prongs being received through a second loop of said first webbing and an opposing second prong of said second pair of prongs being received through a second loop of said second webbing.

12. The system as defined in claim 11, wherein said at least two said pairs of spaced prongs are attached to said plate member along said rear surface, said first pair of prongs extending from a first side portion of said plate member, an opposing second pair of prongs extending from an opposing second side portion of said plate member, said free distal ends of said first and second pairs of prongs being located generally medially of said plate member.

13. The system as defined in claim 12, wherein each said prong is thinner at said free distal end than at said proximal end, said distal end being substantially rounded, such that the shape of said prongs permits easy insertion and wedging of said prongs into respective said loops of respective said webbings of said garment.

14. The system as defined in claim 13, wherein:
said prongs of said first pair of prongs being vertically aligned and said prongs of said second pair of prongs being vertically aligned; and
said first prong of said first pair of prongs being horizontally aligned with said first prong of said second pair of prongs, and a second prong of said first pair of prongs being horizontally aligned with a second prong of said second pair of prongs.

15. The system as defined in claim 11, wherein one of said prongs of said first pair of prongs being horizontally aligned with one of said prongs of said second pair of prongs.

16. The system as defined in claim 15 wherein another of said prongs of said first pair of prongs being horizontally aligned with another of said prongs of said second pair of prongs.

17. The system as defined in claim 11, wherein said plate member further includes a locking spline for affixing an article to said platform at a plurality of angles relative thereto, said locking spline attached to said front surface of said plate member and surrounding an attaching hole extending through said plate member.

18. The system as defined in claim 11, wherein said prongs of said first pair of prongs being vertically aligned and said prongs of said second pair of prongs being vertically aligned.

19. The system as defined in claim 11, wherein:
said prongs of said first pair of prongs being vertically aligned and said prongs of said second pair of prongs being vertically aligned; and
said first prong of said first pair of prongs being horizontally aligned with said first prong of said second pair of prongs, and a second prong of said first pair of prongs being horizontally aligned with a second prong of said second pair of prongs.

20. The system as defined in claim 11, wherein said plate member is generally rectangular.

21. The system as defined in claim 11, wherein said first and second loops of each said first and second webbings being spaced apart by another loop in each said first and second webbings.

22. A method for removably securing articles to a garment, said method comprising the steps of:
affixing an article to a platform by passing a fastener through an opening in a plate member of the platform and using the fastener to secure the article to a front surface of the plate member;
inserting a first pair of horizontally aligned prongs of the platform into respective spaced loops in a first horizontally disposed webbing of the garment;
partially horizontally folding a portion of the garment beneath the platform to permit opposing second pair of horizontally aligned prongs of the platform to be inserted into respective aligned loops in a second spaced horizontally disposed webbing of the garment; and
unfolding the garment to secure the platform and the affixed article to the garment.

23. The method for removably securing articles to a garment as recited in claim 22, further comprising the step of removing the platform from the garment by partially horizontally folding the portion of the garment beneath the platform and selectively removing one of the pairs of prongs from the respective loops in a first horizontally disposed webbing of the garment and thereafter removing the remaining pair of prongs from the respective loops of a second spaced and horizontally disposed second webbing.
